(19) United States
(12) Patent Application Publication
(10) Pub. No.: US 2015/0240830 A1
(43) Pub. Date: Aug. 27, 2015

(54) Thrust Bearing for a Compressor

(71) Applicant: FS-Elliott Co., LLC, Export, PA (US)

(72) Inventors: Edward S. Czechowski, Orchard Park, NY (US); Michael G. Evan, North Huntingdon, PA (US); John R. Badini, Monongahela, PA (US); Matthew S. Zowacki, North Huntingdon, PA (US); Cheng Jin, Monroeville, PA (US); Shane P. Lynch, Monroeville, PA (US)

(21) Appl. No.: 14/190,828

(22) Filed: Feb. 26, 2014

(51) Int. Cl. F04D 29/056; F04D 29/063; F04D 17/10; F16C 17/04

(52) U.S. Cl. CPC F04D 29/056; F16C 17/04; F04D 29/063; F04D 17/10

(57) ABSTRACT

An integrally-geared centrifugal compressor has a drive mechanism and a gear box operatively engaged with the drive mechanism. The gear box includes a main input gear driven by the drive mechanism and a pinion shaft driven by the main input gear. The pinion shaft is driven at a higher rotational speed (generally above the first critical speed) compared to the main input gear. The compressor further includes at least one process stage for compressing a fluid medium. The at least one process stage has at least one centrifugal compressor with at least one impeller operatively engaged with the pinion shaft. At least one thrust bearing having a bearing surface is provided in operative engagement with the pinion shaft. The bearing surface is made from a non-metallic material, such as a poly-ether-ether-ketone (PEEK) or equivalent material.

### BACKGROUND OF THE INVENTION

1. Field of the Invention

The present disclosure relates generally to a thrust bearing for use on a compressor. More particularly, the present disclosure relates to a thrust bearing having a non-metallic pad material for use on an integrally-geared centrifugal compressor.

2. Description of the Related Art

Compressors are commonly used in a variety of industries. Certain industrial processes often require a delivery of high volumes of a fluid medium, such as air or a chemical gas, at high pressures, typically ranging from 25 to 600 psig. In order to meet these industrial demands, a variety of centrifugal compressors have been developed. These compressors may have one or more compressor stages. In a multi-stage compressor, the fluid medium is compressed to a first pressure in a first stage which is then fed to one or more additional stages, where it is compressed to a pressure higher than the first pressure.

Integrally-geared centrifugal compressors are often used to compress the fluid medium in a variety of industrial processes. The integrally-geared centrifugal compressor has a large bull gear that is driven by a driver, such as a motor or a turbine. The bull gear is geared with a smaller pinion shaft, such that the pinion shaft is driven at a higher speed than the bull gear. The pinion shaft has at least one impeller provided in a casing volute. The impeller is rotated synchronously with the pinion shaft to draw low-pressure fluid medium into the housing and increase the pressure of the fluid medium as it drawn from the housing inlet to the housing outlet.

The pinion shaft is typically supported by a bearing assembly that supports the radial and axial forces exerted on the pinion shaft.

The bearing assembly may include a thrust bearing that includes a bearing surface for forces acting in an axial direction of the pinion shaft. The thrust bearing provides an interface between the rotating pinion shaft and the casing volute of the compressor. In one embodiment, a rider ring is provided proximate to the bull gear such that the thrust loads on the pinion shaft are transferred to the much larger bull gear. Rider rings have thrust limits and are limited in terms of industrial application. In other embodiments, it is common to employ one or more pads at the interface with the pinion shaft. For example, the one or more pads have a tapering pad surface that creates a tapered oil film that is in contact with the pinion shaft. The remaining surface of the tapering pad is inclined such that lubricant may be channeled into it. In operation, a lubricant film is formed due to a buildup of hydrostatic pressure generated between the rotating pinion shaft and the stationary pad to define a self-acting thrust load support surface. Tapering land bearings are best suited for compressors that operate under specific, constant speed conditions. In another embodiment, the one or more pads are pivotally movable relative to the surface of the pinion shaft. Each pad can tilt individually to generate a self-sustaining hydrodynamic film during bearing operation.

In embodiments where the bearing has a thrust pad, the pad surface is typically formed from a metallic material, such as Babbit, coated steel, or bronze. The type of the one or more pads defines the load capacity, mechanical losses, and lubrication requirements of the thrust bearing. These characteristics directly affect the overall compressor mechanical efficiency. As the rotational speeds of the compressor increase, several unique challenges arise in relation to the design of the thrust bearings. In high speed operations, where the pinion shaft operates at a speed in the range of 15,000 to 70,000 rpm (generally above the first critical speed), the thrust bearing has a running clearance for setting axial position of the impeller relative to the stationary housing. This imposes high lubrication requirements in order to prevent direct contact between the pad surface and the rotating pinion shaft. Additionally, in order to support the thrust loads during high speed operation, the pads must have a large bearing area, which increases the mechanical loss of the thrust bearing. Furthermore, the metallic material of the thrust pads is subject to temperature limitations, which further increases the lubrication requirements. Additionally, static electricity can be built up within the metal housing of the compressor. The metallic material on the thrust pad surface can cause a discharge of static (DC) or AC electricity on the thrust face. This electrical discharge can cause damage to the surface of the thrust face, thereby requiring frequent servicing or replacement.

### SUMMARY OF THE INVENTION

Accordingly, in view of the disadvantages of the existing thrust bearings for integrally-geared centrifugal compressors, an improved bearing that overcomes these disadvantages is desired. In one embodiment of the present invention, an integrally-geared compressor may have a drive mechanism and a gear box operatively engaged with the drive mechanism. The gear box may include a main input gear driven by the drive mechanism and a pinion shaft driven by the main input gear. The pinion shaft may be driven at a higher rotational speed compared to the main input gear. The compressor may further include at least one process stage for compressing a fluid medium. The at least one process stage may have at least one centrifugal compressor with at least one impeller operatively engaged with the pinion shaft. At least one thrust bearing may have a bearing surface and is provided in operative engagement with the pinion shaft. The bearing surface may be made from a non-metallic material, such as a poly-ether-ether-ketone (PEEK) material.

In another embodiment, the bearing surface may have an array of tiltable pads arranged in a circular configuration. The array of pads may have a bottom substrate with the non-metallic material deposited on the bottom substrate. The thrust bearing may have a substantially annular shape with a central opening for receiving the pinion shaft. The central opening may include one or more journal pads. At least one lubrication passage may be provided for delivering lubricant to the bearing surface. The thrust bearing may further include an outer retainer that extends around a concentrically-arranged carrier, wherein the bearing surface is disposed on the carrier.

In accordance with a further embodiment, a thrust bearing for a multi-stage, integrally-. geared compressor may have an outer retainer having a substantially annular shape and a carrier concentrically-arranged within the outer retainer. The carrier may have a substantially annular shape with a central opening. One or more journal pads may be disposed in the central opening, where the one or more journal pads are configured for operatively engaging a pinion shaft of the compressor. The bearing may further have an array of pads in a circular arrangement on the carrier. The array of pads defines a bearing surface, which may be made from a non-metallic material. The non-metallic material may be a PEEK or an equivalent material. The array of pads may further include a bottom substrate with the non-metallic material deposited on the bottom substrate. At least one lubrication passage may be provided for delivering lubricant to the bearing surface. Additionally, at least one sensor for measuring a performance characteristic of the bearing may optionally be provided. The at least one sensor may be a temperature sensor or a shaft motion sensor.

In a further embodiment, a drive assembly for a multi-stage, integrally-geared compressor may have a drive mechanism and a gear box operatively engaged with the drive mechanism. The gear box may include a main input gear driven by the drive mechanism and a pinion shaft driven by the main input gear. The pinion shaft may be driven at a higher rotational speed compared to the main input gear. At least one thrust bearing may have a bearing surface, which is in operative engagement with the pinion shaft. The bearing surface may be made from a non-metallic material, such as a PEEK material. The bearing surface may have an array of tiltable pads arranged in a circular configuration. The array of pads may have a bottom substrate with the non-metallic material deposited on the bottom substrate. The thrust bearing may have a substantially annular shape with a central opening for receiving the pinion shaft. At least one lubrication passage may be provided for delivering lubricant to the bearing surface.

These and other features and characteristics of the thrust bearing for a compressor, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a perspective view of a packaged compressor assembly in accordance with one embodiment of the present invention;

FIG. 2 is a perspective view of a multi-stage, integrally-geared centrifugal compressor shown in FIG. 1;

FIG. 3 is an enlarged view of Detail A shown in FIG. 2;

FIG. 4 is a perspective view of a pinion shaft and thrust bearing assembly shown in FIG. 3; and

FIG. 5 is a perspective view of a thrust bearing shown in FIG. 4.

### DETAILED DESCRIPTION OF THE INVENTION

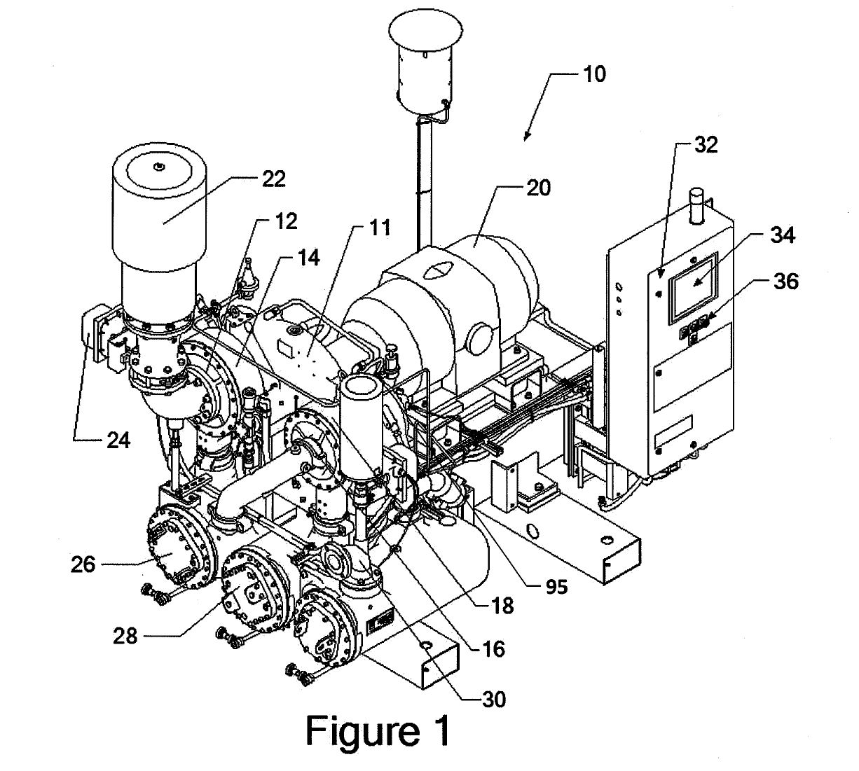

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting. 100181 Referring to FIG. 1, a compressor assembly 10 is illustrated. The compressor assembly 10 is a multi-stage, integrally-geared centrifugal compressor assembly configured for pressurizing a fluid medium, such as air or an industrial gas, for use in an industrial process. While a multi-stage compressor assembly 10 is illustrated in FIG. 1, one of ordinary skill in the art will appreciate that, depending on a desired output pressure and volume, a single-stage compressor assembly may be contemplated. In another embodiment, a multi-stage compressor with two or more high-speed pinions is also contemplated.

The compressor assembly 10 includes a first process stage 12 in the form of a first centrifugal compressor 14 and second process stage 16 in the form of a second centrifugal compressor 18. The first and second compressors 14, 18 are driven by a drive mechanism 20. In one embodiment, the drive mechanism 20 is an electric motor that is operated at a substantially constant rotational speed of 1450 to 3600 rpm. The drive mechanism 20 drives the first and second compressors 14, 18 by way of a geared connection, as will be described in detail hereinafter. While the drive mechanism 20 shown in FIG. 1 is embodied as an electric motor, other embodiments of the drive mechanism 20 are not precluded. For example, the drive mechanism 20 may be embodied as a turbine, such as a steam or a gas turbine.

As the drive mechanism 20 drives the first compressor 14, the fluid medium is drawn into the first compressor 14 through the intake 22. A throttle valve 24 controls the volume of the fluid medium passing through the intake 22 and entering the first compressor 14. The fluid medium is compressed in the first compressor 14 to a first pressure, which is higher than the intake pressure of the fluid medium. The compressed fluid medium discharged from the first compressor 14 to a first heat exchanger 26, which reduces the temperature of the fluid medium before it is introduced into the second compressor 18. The second compressor 18 increases the pressure of the fluid medium to a second pressure, which is desirably higher than the first pressure. In order to reduce the temperature of fluid medium after it is compressed by the second compressor 18, the fluid medium is discharged to a second heat exchanger 28. One or more additional process stages (not shown) may be incorporated to further increase the pressure of the fluid medium. The pressurized fluid medium is discharged through an outlet 30.

With continued reference to FIG. 1, the compressor assembly 10 serves to compress the fluid medium to a pressure higher than the intake pressure. For example, in the first process stage 12, the fluid medium may be compressed to a pressure of −5 to 50+ psia. The fluid medium heated by compression in the first process stage 12 is cooled in the first heat exchanger 26. In the second process stage 16, the fluid medium is compressed to a pressure of up to 150 psia, for example, (unless used as a booster, where the pressure may exceed this value) before being cooled in the second heat exchanger 28 and discharged through the outlet 30. The pressures and volumes described hereinabove are exemplary only and may be varied to suit a desired industrial application.

The operation of the compressor assembly 10 may be monitored and controlled by a control panel 32. The control panel 32 may have a display 34 configured for displaying the operating characteristics of the compressor assembly 10. For example, the display 34 may indicate the operating speed of the compressor assembly 10, and pressure and volume flow output of the first and second process stages 12, 16. The display 34 may also show any warnings indicative of an abnormal running condition of the compressor assembly 10. A plurality of controls 36, such as buttons or knobs, are provided to control the operation of the compressor assembly 10.

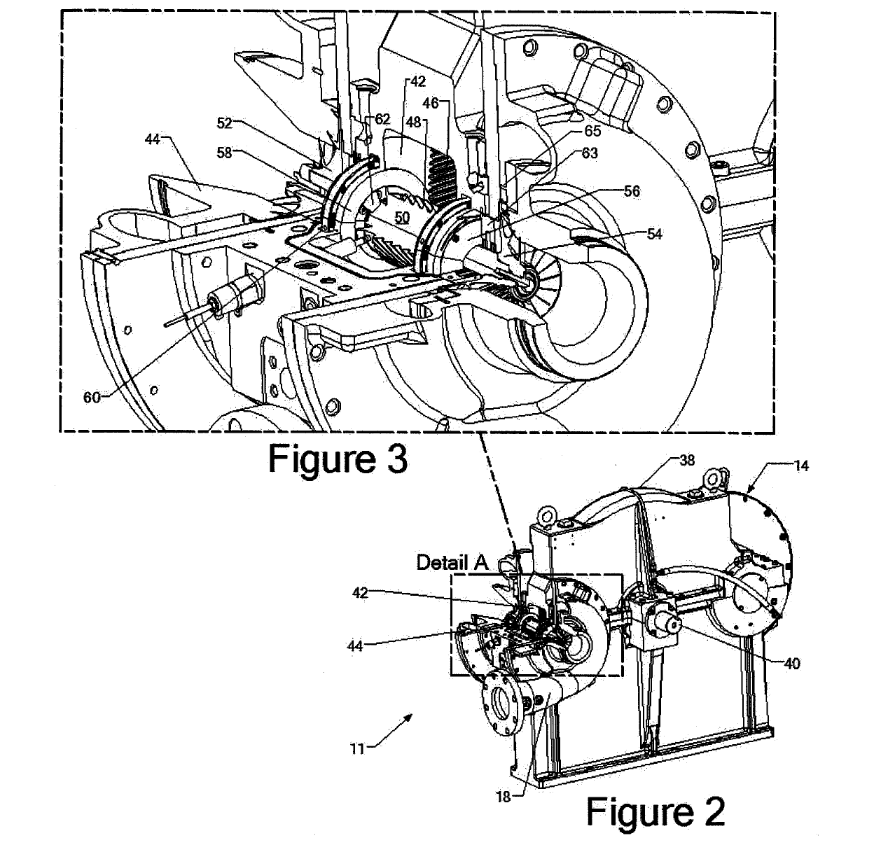

With reference to FIG. 2, a compressor 11 having a first compressor 14, a second compressor 18, and a third stage 95 is illustrated. The compressor 11 has a housing 38 for enclosing the internal components of the first and second compressors 14, 18. The housing 38 also receives a main drive gear that is driven by the drive mechanism (shown in FIG. 1) by way of a drive shaft 40. The drive shaft 40 receives the power input from the drive mechanism 20 (shown in FIG. 1) and transfers the power input to the first and second compressors 14, 18 by way of the main drive gear, as will be described hereinafter.

The housing 38 is divided into a plurality of separate chambers, which are isolated from each other in a pressure-tight manner. As will be described in detail hereinafter, the housing 38 has a gear chamber 42 for enclosing the drivetrain of the compressor 11. Each of the first and second compressors 14, 18 has a casing volute 44 that defines the pressure chamber therein. The gear chamber 42 is separated in a pressure-tight manner from the casing volute 44 of the first and second compressors 14, 18, such that substantially minimal compressed or uncompressed fluid medium enters the gear chamber 42.

With reference to FIG. 3, an enlarged view of Detail A shown in FIG. 2 is illustrated. FIG. 3 illustrates an enlarged view of a partial cross-section of the second compressor 18. While the following disclosure will be focused on describing the operation of the second compressor 18, it is to be understood that the first compressor 14 operates in an identical manner and a detailed description of the operating principle of the first compressor 14 is omitted for brevity. As shown in FIG. 3, the gear chamber 42 encloses a main input gear, hereinafter referred to as a bull gear 46. The bull gear 46 is driven directly by the drive shaft 40 (shown in FIG. 2) that receives the power input from the drive mechanism 20 (shown in FIG. 1). In this manner, the bull gear 46 is driven at a same input speed as the drive mechanism 20 (i.e., <3600 rpm). The bull gear 46 is in a geared connection with a pinion gear 48 of a pinion shaft 50 that extends along a central axis of the second compressor 18. For example, the bull gear 46 and the pinion shaft 50 may have a helical gear connection. In another embodiment, the gear connection between the bull gear 46 and the pinion shaft 50 may be realized by way of a spur gear connection. Because the pinion shaft 50 has a substantially smaller diameter compared to the bull gear 46 (on the order of 7:1 to 23:1), the pinion shaft 50 is driven at a rotational speed that is significantly higher than the rotational speed of the bull gear 46. In one exemplary and non-limiting embodiment, for a bull gear 46 rotational speed of 3600 rpm and a gear ratio between the bull gear 46 to the pinion shaft 50 of 10.96:1, the resulting rotational speed of the pinion shaft 50 is 39,456 rpm.

The pinion shaft 50 has a low-pressure impeller 52 disposed at one end and a high-pressure impeller 54 disposed at the opposite end. The low- and high-pressure impellers 52, 54 are enclosed inside the casing volute 44. Pressurized fluid medium from the first process stage 12 (shown in FIG. 1) is acted on by the low-pressure impeller 52, which, in combination with a diffuser section 65 pressurizes the fluid medium before it is acted on by the high-pressure impeller 54.

With continued reference to FIG. 3, the pinion shaft 50 is supported within the gear chamber 42 of the housing 38 by a pair of journal bearings 56 that support the vertical loads on the pinion shaft 50. Thrust loads imposed on the pinion shaft 50 are handled by a pair of thrust bearings 58. Each thrust bearing 58 is received within a bearing housing 60 on the housing 38. The thrust forces imposed on the thrust bearing 58 are transferred to the housing 38 by way of the bearing housing 60. A pair of seals 63 is provided between the thrust bearings 58 and the low- and high-pressure impellers 52, 54 to separate the gear chamber 42 from the casing volute 44 in a pressure-tight manner. The seals 63 prevent the compressed fluid medium from entering the gear chamber 42, while simultaneously preventing the lubricant from the gear chamber 42 from entering the casing volute 44.

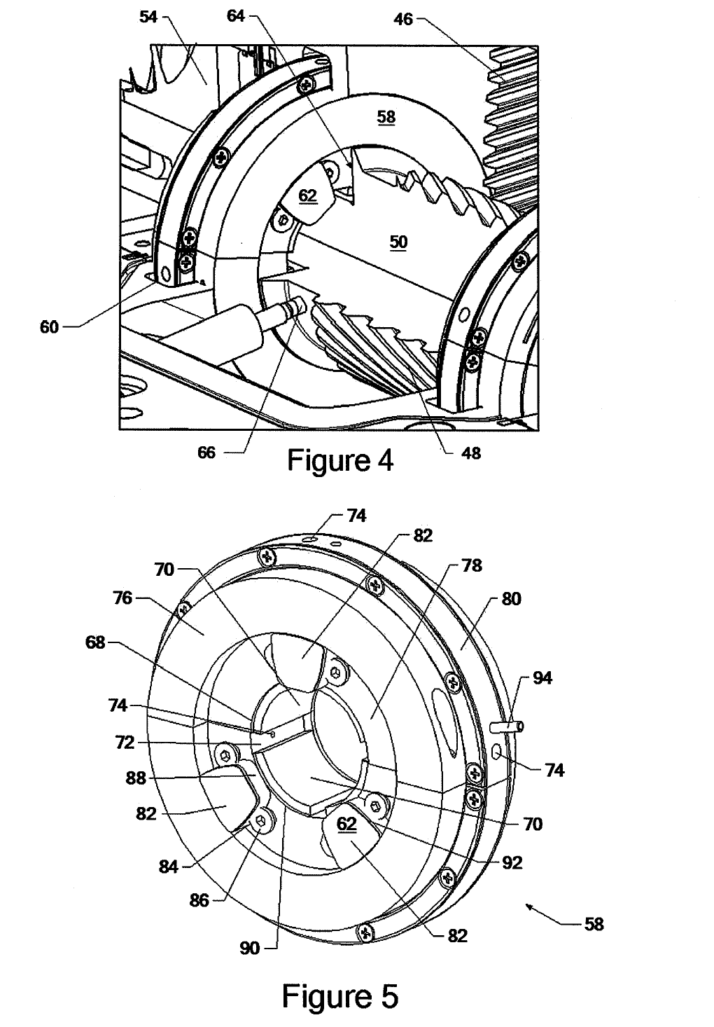

With reference to FIG. 4, an enlarged view of the thrust bearing 58 located proximate to the high-pressure impeller 54 is illustrated. The thrust bearing 58 is arranged such that its bearing surface 62 is located opposite a thrust collar 64 of the pinion shaft 50. In operation, lubricant is injected at annulus 60 to aid in the formation of a hydrodynamic film at the interface between the bearing surface 62 of the thrust bearing 58 and the thrust collar 64 of the pinion shaft 50. Specifically, the rotation of the thrust collar 64 of the pinion shaft 50 sucks the lubricant to the interface between the bearing surface 62 of the thrust bearing 58 and the thrust collar 64.

Turning to FIG. 5, the combination journal/thrust bearing 58, hereinafter referred to as bearing 58, is shown removed from the compressor 11. The bearing 58 has a generally annular shape with a central opening 68 configured for receiving the pinion shaft 50. The central opening 68 includes a plurality of journal pads 70 segmented around a sidewall of the central opening 68. The journal pads 70 extend radially inward from the sidewall of the central opening 68. Adjacent journal pads 70 are separated by a gap 72 having a lubricant passage 74 for introducing the lubricating lubricant to the journal pads 70. The interaction of the lubricant with the journal pads 70 achieves the desired hydrodynamic effect for supporting the pinion shaft 50 on a thin film of a mineral and/or synthetic lubricant. While FIG. 5 illustrates three journal pads 70, it is to be appreciated that more or fewer journal pads 70 may be provided. For example, the bearing 58 may have 3 to 8 journal pad segments.

With continued reference to FIG. 5, the annular shape of the bearing 58 is defined by an outer retainer 76 that extends around a carrier 78. As illustrated in FIG. 5, the retainer 76 and the carrier 78 are arranged concentrically, with the carrier 78 being recessed within the retainer 76. The retainer 76 and the carrier 78 are rotationally connected to each other. The retainer 76 is secured in the bearing housing 60 of the gear chamber 42 (shown in FIG. 4). For example, the retainer 76 may be secured by inserting a lip 80 extending around the outer circumference of the retainer 76 into the bearing housing 60, as shown in FIG. 4.

An array of pads 82 is disposed in a circumferential arrangement around the carrier 78. The pads 82 define the bearing surface 62 of the bearing 58. The pads 82 have a generally trapezoidal shape, with parallel bases spaced apart in a radial direction. While FIG. 5 illustrates the pads 82 as having a trapezoidal shape, it is to be understood that any other shape may be used to meet the requirements of the bearing 58. The pads 82 respectively reside in pad seats 84 arranged circumferentially within the carrier 78. Each pad 82 includes a pair of locking tabs 86 that capture the pad 82 therebetween. Oil then flows from the area of the journal pads 70 to the bearing surface 62 of the pads 82.

A lower portion 88 of the pad 82 proximate to the carrier 78 is supported on a tilt member 90 that extends radially from an outer circumference of the carrier 78 to an inner circumference of the carrier 78. Each pad 82 is positioned such that a middle part of its lower portion 88 rests on the tilt member 90. In this manner, the tilt member 90 defines a tilt axis that allows the pad 82 to tilt on either side of the tilt member 90. Each pad 82 may be tilted individually in order to optimize its position during operation such that lubricant may enter the space between the upper surface of the pad 82 and the pinion shaft 50. Additionally, the pads 82 can tilt on their axes as the pinion shaft 50 goes through critical speeds during operation. This eliminates edge loading typically found on fixed pad systems.

With continued reference to FIG. 5, an upper portion 92 of each pad 82 is substantially planar and is formed from a non-metallic material, such as a PEEK material or an equivalent. The lower portion 88 of the pad 82 may be formed from metal to define a substrate for depositing the PEEK material on the upper portion 92. Alternatively, the entire pad 82 may be formed from the PEEK material. PEEK material is a high performance polymer suitable for high-temperature applications where thermal properties are critical for performance. The PEEK material offers superior thermal and wear resistance characteristics compared to conventional pad materials, such as Babbit. Specifically, a non-metallic material, such as PEEK, has a higher melting temperature compared to Babbit (450° F. for PEEK compared to 350° F. for Babbit), which enables higher loads while maintaining softness. This allows the bearing pads having a non-metallic material, such as PEEK, to absorb more contaminants compared to their Babbit counterparts.

The non-metallic materials, such as the PEEK material and PEEK-like materials, have a higher specific load capacity compared to conventional bearing pad materials of equal load area, which allows for a reduction in surface area of the pads 82 compared to conventional bearings. Because the surface area of the pads is directly correlative to frictional losses during operation, pads 82 having the PEEK material can realize a significant reduction in frictional losses due to a reduction in the surface area of the bearing 58. For example, a non-metallic thrust bearing can reduce mechanical losses by up to 25%.

Another advantage of using PEEK material on the pads 82 is the reduction in lubrication requirements. Because the pads 82 are made with a reduced surface area compared to conventional bearing pads, less lubricant is required to achieve full hydrodynamic lubrication. In this manner, a more compact lubrication system with smaller lubricant pumps, valves, and filters can be used.

The pads 82 may further have one or more additional layers or coatings thereon (not shown), which are dependent on the application and needs for the bearing 58. By interacting with the lubricant, the pads 82 achieve the desired hydrodynamic effect for carrying the thrust load imposed by the pinion shaft 50.

Because PEEK is a non-metallic material, the pads 82 act as an electrically-insulating layer between the bearing 58 and the pinion shaft 50. Thus, any static charges that may build up in the pinion shaft 50 during operation of the compressor 11 are not discharged to the bearing 58. In this manner, the use of PEEK material avoids damage to the bearing 58 as a result of electrical discharge. Optionally, the bearing 58 may be provided with a metal brush grounding ring (not shown) to completely insulate the compressor 11 from electrical discharge. The bearing 58 may also be equipped with one or more sensors (not shown), such as load cells, temperature, and position sensors, to measure various running conditions of the bearing 58.

While various embodiments of the thrust bearing for a compressor were provided in the foregoing description, those skilled in the art may make modifications and alterations to these embodiments without departing from the scope and spirit of the invention. For example, it is to be understood that this disclosure contemplates that, to the extent possible, one or more features of any embodiment can be combined with one or more features of any other embodiment. Accordingly, the foregoing description is intended to be illustrative rather than restrictive. The invention described hereinabove is defined by the appended claims and all changes to the invention that fall within the meaning and the range of equivalency of the claims are to be embraced within their scope.

What is claimed is:

1. An integrally-geared centrifugal compressor, comprising:
a drive mechanism;
a gear box operatively engaged with the drive mechanism, the gear box comprising:
a main input gear driven by the drive mechanism; and
a pinion shaft driven by the main input gear, wherein the pinion shaft is driven at a higher rotational speed compared to the main input gear;
at least one process stage for compressing a fluid medium, the at least one process stage having at least one centrifugal compressor with at least one impeller operatively engaged with the pinion shaft; and
at least one thrust bearing having a bearing surface in operative engagement with the pinion shaft,
wherein the bearing surface is made from a non-metallic material.

2. The compressor of claim 1, wherein the non-metallic material is a poly-ether-ether-ketone (PEEK) material.

3. The compressor of claim 1, wherein the bearing surface comprises an array of tillable pads arranged in a circular configuration.

4. The compressor of claim 3, wherein the array of pads comprises a bottom substrate with the non-metallic material deposited on the bottom substrate.

5. The compressor of claim 1, wherein the thrust bearing has a substantially annular shape with a central opening for receiving the pinion shaft.

6. The compressor of claim 5, wherein the central opening comprises one or more journal pads.

7. The compressor of claim 1, wherein the thrust bearing comprises at least one lubrication passage for delivering lubricant to the bearing surface.

8. The compressor of claim 1, wherein the thrust bearing comprises an outer retainer that extends around a concentrically-arranged carrier, wherein the bearing surface is disposed on the carrier.

9. A thrust bearing for a multi-stage, integrally-geared compressor, the thrust bearing comprising:
an outer retainer having a substantially annular shape;
a carrier concentrically-arranged within the outer retainer, the carrier having a substantially annular shape with a central opening;
one or more journal pads disposed in the central opening, the one or more journal pads configured for operatively engaging a pinion shaft of the compressor; and
an array of pads in a circular arrangement on the carrier, the array of pads defining a bearing surface,
wherein the bearing surface is made from a non-metallic material.

10. The thrust bearing of claim 9, wherein the non-metallic material is a poly-ether-ether-ketone (PEEK) material.

11. The thrust bearing of claim 9, wherein the array of pads comprises a bottom substrate with the non-metallic material deposited on the bottom substrate.

12. The thrust bearing of claim 9, further comprising at least one lubrication passage for delivering lubricant to the bearing surface.

13. The thrust bearing of claim 9, further comprising at least one sensor for measuring a performance characteristic of the bearing.

14. The thrust bearing of claim 13, wherein the at least one sensor is a temperature sensor or a load sensor.

15. A drive assembly for a multi-stage, integrally-geared compressor, the drive assembly comprising:
a drive mechanism;
a gear box operatively engaged with the drive mechanism, the gear box comprising:
a main input gear driven by the drive mechanism; and
a pinion shaft driven by the main input gear, wherein the pinion shaft is driven at a higher rotational speed compared to the main input gear; and
at least one thrust bearing having a bearing surface in operative engagement with the pinion shaft,
wherein the bearing surface is made from a non-metallic material.

16. The drive assembly of claim 15, wherein the non-metallic material is a poly-ether-ether-ketone (PEEK) material.

17. The drive assembly of claim 15, wherein the bearing surface comprises an array of likable pads arranged in a circular configuration.

18. The drive assembly of claim 17, wherein the array of pads comprises a bottom substrate with the non-metallic material deposited on the bottom substrate.

19. The drive assembly of claim 15, wherein the thrust bearing has a substantially annular shape with a central opening for receiving the pinion shaft.

20. The drive assembly of claim 15, wherein the thrust bearing comprises at least one lubrication passage for delivering lubricant to the bearing surface.
